(19) United States
(12) Patent Application Publication
(10) Pub. No.: US 2026/0142385 A1
(43) Pub. Date: May 21, 2026

(54) CRIMP TERMINAL AND CRIMP CONNECTOR

(71) Applicant: Xuancheng Luxshare Precision Industry Co., Ltd, Xuancheng City (CN)

(72) Inventors: Shuwei LI, Xuancheng City (CN); Guanghai GUO, Xuancheng City (CN); Shuguang CHEN, Xuancheng City (CN)

(73) Assignee: Xuancheng Luxshare Precision Industry Co., Ltd, Xuancheng City (CN)

(21) Appl. No.: 19/240,810

(22) Filed: Jun. 17, 2025

(30) Foreign Application Priority Data
Nov. 18, 2024 (CN) 202422811224.2

(51) Int. Cl. H01R 4/20; H01R 43/16

(52) U.S. Cl. CPC H01R 4/206; H01R 43/16

(57) ABSTRACT

A crimp terminal includes a main body, a pin portion, a first elastic portion, a second elastic portion, and an elastic support structure. The first elastic portion is connected between the main body and the pin portion and can be at least deformed in the second direction. The second elastic portion is connected between the main body and the pin portion and can be at least deformed in the second direction. The elastic support structure is connected between the first elastic portion and the second elastic portion, the cross-sectional shape of the elastic support structure perpendicular to the first direction is V-shaped, and the elastic support structure includes a first end edge facing the main body and a second end edge. The first end edge is at least partially recessed toward the pin portion, and the second end edge is at least partially recessed toward the main body.

### CROSS-REFERENCE TO RELATED APPLICATION(S)

This application claims priority to Chinese Patent Application No. 202422811224.2 filed Nov. 18, 2024, the disclosure of which is incorporated herein by reference in its entirety.

### TECHNICAL FIELD

The present disclosure relates to the technical field of connectors and, for example, to a crimp terminal and a crimp connector.

### BACKGROUND

A crimp connector is a commonly used connector for communication between electronic devices. The crimp connector uses crimp terminals (that is, press-fit contact terminals) to form effective electrical conduction with the electronic devices such as printed circuit boards, thereby enabling the transmission of electrical signals between the electronic devices.

In the related art, crimp connectors mainly include two types according to different crimp terminals. In a kind of crimp connectors, crimp terminals are solid terminals and make hard contact with electronic devices after being inserted into the electronic devices such as printed circuit boards. In the other kind of crimp connectors, crimp terminals are deformable terminals with an elastic deformation portion. For example, a crimp terminal is provided with a fisheye hole, and two portions forming the fisheye hole are referred to as elastic arms; when the crimp terminal is inserted into an insertion hole of a printed circuit board, the elastic arms are elastically deformed and abut against the hole wall of the insertion hole, and the holding force of the crimp terminal comes from the action force between the elastic arms and the hole wall of the insertion hole.

It can be seen that the holding force of the crimp terminal in the related art has a single source, resulting in a small interaction force between the elastic arms and the hole wall of the insertion hole and further leading to low connection reliability between the crimp terminal and an electronic device such as a printed circuit board. When applied in an electronic device with large vibration amplitude, the crimp terminal has poor contact with the electronic device, affecting the continuity and stability of electrical signal transmission.

### SUMMARY

The present disclosure provides a crimp terminal and a crimp connector to solve low connection reliability and poor contact in the related art.

A crimp terminal is provided. The crimp terminal includes a main body, a pin portion, a first elastic portion, a second elastic portion, and an elastic support structure.

The pin portion is spaced apart from the main body in a first direction.

The first elastic portion is connected between the main body and the pin portion, where the first elastic portion is at least deformable in a second direction perpendicular to the first direction.

The second elastic portion is connected between the main body and the pin portion and spaced apart from the first elastic portion in the second direction, where the second elastic portion is at least deformable in the second direction.

The elastic support structure is located between the first elastic portion and the second elastic portion and connected to the first elastic portion and the second elastic portion, where a cross-sectional shape of the elastic support structure perpendicular to the first direction is V-shaped; the elastic support structure includes a first end edge facing the main body and a second end edge facing away from the main body; the first end edge is at least partially recessed toward the pin portion, and the second end edge is at least partially recessed toward the main body.

Optionally, the crimp terminal further includes at least one of the following: the first end edge includes a first plane and a second plane that are disposed at an included angle; or the second end edge includes a third plane and a fourth plane that are disposed at an included angle.

Optionally, the elastic support structure is provided in a quantity of one, and the elastic support structure is connected to a middle portion of the first elastic portion in the first direction and a middle portion of the second elastic portion in the first direction.

Optionally, a fisheye hole is enclosed by the main body, the pin portion, the first elastic portion, and the second elastic portion, and the elastic support structure is disposed in the fisheye hole and separates the fisheye hole into a first through hole and a second through hole.

Optionally, the fisheye hole, the first through hole, the second through hole, and the elastic support structure are all axisymmetric structures, and symmetry axes of the fisheye hole, the first through hole, the second through hole, and the elastic support structure coincide and extend along the first direction.

Optionally, the first elastic portion includes a first wall surface and a second wall surface, and the second elastic portion includes a third wall surface and a fourth wall surface; the first wall surface and the third wall surface are disposed at an included angle, and the second wall surface and the fourth wall surface are disposed at an included angle; the first wall surface, the second wall surface, the third wall surface, and the fourth wall surface are all planes.

Optionally, the included angle between the first wall surface and the third wall surface is a1, and the included angle between the first plane and the second plane is b1, where b1>a1; and the included angle between the second wall surface and the fourth wall surface is a2, and the included angle between the third plane and the fourth plane is b2, where b2>a2.

Optionally, the first elastic portion further includes a fifth wall surface connected between the first wall surface and the second wall surface; the second elastic portion further includes a sixth wall surface connected between the third wall surface and the fourth wall surface; and the first plane intersects the first wall surface, and a position at which the first plane intersects the first wall surface is different from a position at which the first wall surface intersects the fifth wall surface; the second plane intersects the third wall surface, and a position at which the second plane intersects the third wall surface is different from a position at which the third wall surface intersects the sixth wall surface; the third plane intersects the second wall surface, and a position at which the third plane intersects the second wall surface is different from a position at which the second wall surface intersects the fifth wall surface; the fourth plane intersects the fourth wall surface, and a position at which the fourth plane intersects the fourth wall surface is different from a position at which the fourth wall surface intersects the sixth wall surface.

Optionally, the first elastic portion has a first side surface and a second side surface that are opposite to each other in a third direction; a distance from a connection position of the elastic support structure and the first elastic portion to the first side surface is L1, a distance from the connection position of the elastic support structure and the first elastic portion to the second side surface is L2, and L1□L2; a middle portion of the elastic support structure extends toward the second side surface, where the third direction is perpendicular to both the first direction and the second direction.

A crimp connector is provided. The crimp connector includes the preceding crimp terminal.

### BRIEF DESCRIPTION OF DRAWINGS

FIG. 1 is view one illustrating the structure of a crimp terminal according to an embodiment.

FIG. 2 is view two illustrating the structure of a crimp terminal according to an embodiment.

FIG. 3 is a front view of a crimp terminal according to an embodiment.

FIG. 4 is a cross-sectional view of a crimp terminal perpendicular to a first direction according to an embodiment.

FIG. 5 is a force distribution view of a crimp terminal according to an embodiment.

### DETAILED DESCRIPTION

The present disclosure is further described below in detail in conjunction with the drawings and embodiments. It is to be understood that the embodiments described herein are intended to illustrate and not to limit the present disclosure. Additionally, it is to be noted that for ease of description, part, not all, of structures related to the present disclosure are illustrated in the drawings.

In the description of the present disclosure, unless otherwise expressly specified and limited, the term “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected or an interactional relationship between two elements. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, it is to be noted that orientations or position relations indicated by terms such as “above”, “below”, and “right” are based on the drawings. These orientations or position relations are intended to facilitate the description and simplify an operation and not to indicate or imply that a device or element referred to has a particular orientation or is configured or operated in a particular orientation. Thus, these orientations or position relations are not to be construed as limiting the present disclosure. Additionally, terms “first” and “second” are used for distinguishing between descriptions and have no special meanings.

The technical solutions of the present disclosure are further described below in conjunction with the drawings and the embodiments.

In a first aspect, this embodiment provides a crimp terminal that can improve the connection reliability and lower the risk of poor contact, thereby ensuring the continuity and stability of electrical signal transmission.

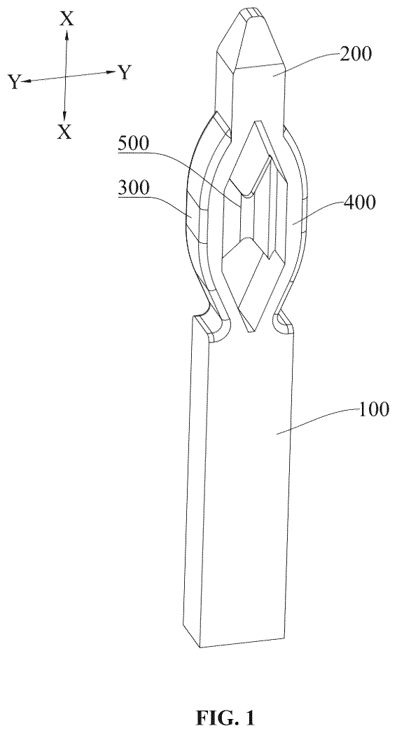

As shown in FIGS. 1 to 4, the crimp terminal includes a main body 100, a pin portion 200, a first elastic portion 300, a second elastic portion 400, and an elastic support structure 500. Exemplarily, the crimp terminal is an integrated structure to have a high structural strength. The crimp terminal is made of a conductive material such as metal. The crimp terminal can be inserted into an insertion hole of a target electronic device such as a printed circuit board along the first direction X, and the hole wall of the insertion hole has, for example, a metal layer made of copper so that the crimp terminal can be mechanically connected to the target electronic device while achieving electrical connection.

The main body 100 is used for connecting a conductor such as a wire. Exemplarily, the main body 100 may extend linearly along the first direction X. The pin portion 200 is spaced apart from the main body 100 in the first direction X and is used for guiding the insertion into the insertion hole. Therefore, the pin portion 200 is usually provided with a tip to facilitate insertion into the insertion hole. The pin portion 200 may extend linearly along the first direction X. For example, the main body 100 and the pin portion 200 may be coaxially disposed to make the structure of the crimp terminal symmetrical.

As shown in FIG. 1, the first elastic portion 300 is connected between the main body 100 and the pin portion 200. Specifically, one end of the first elastic portion 300 is connected to an end portion of one end of the main body 100 facing the pin portion 200, and the other end of the first elastic portion 300 is connected to an end portion of one end of the pin portion 200 facing the main body 100.

In this embodiment, the second elastic portion 400 is connected between the main body 100 and the pin portion 200 and is spaced apart from the first elastic portion 300 in the second direction Y. Specifically, one end of the second elastic portion 400 is connected to an end portion of one end of the main body 100 facing the pin portion 200, and the other end of the second elastic portion 400 is connected to an end portion of one end of the pin portion 200 facing the main body 100.

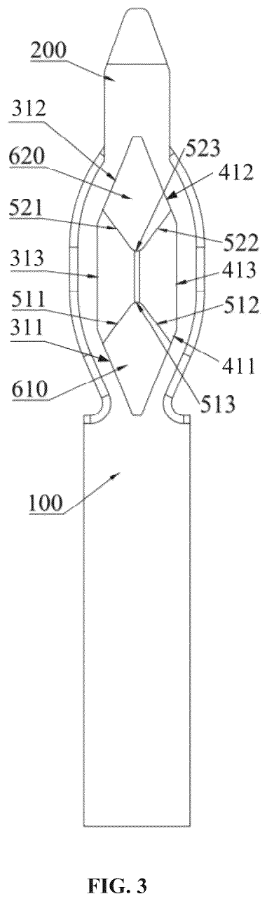

Furthermore, the first elastic portion 300 can be at least deformed in the second direction Y perpendicular to the first direction X so as to be in close contact with the hole wall of the insertion hole. The second elastic portion 400 can be at least deformed in the second direction Y so as to be in close contact with the hole wall of the insertion hole. Both the first elastic portion 300 and the second elastic portion 400 can be deformed in the second direction Y so that the first elastic portion 300 can bulge toward one side of the second direction Y, and the second elastic portion 400 can bulge toward the other side of the second direction Y. In FIG. 3, the first elastic portion 300 bulges toward the left side of the figure, and the second elastic portion 400 bulges toward the right side of the figure. Both the first elastic portion 300 and the second elastic portion 400 bulge and can cooperate with the main body 100 and the pin portion 200 to enclose a fisheye hole 600. After the crimp terminal is inserted into the insertion hole of the target electronic device, the first elastic portion 300 and the second elastic portion 400 are pressed by the hole wall of the insertion hole so that the first elastic portion 300 and the second elastic portion 400 can be elastically deformed close to each other in the second direction Y.

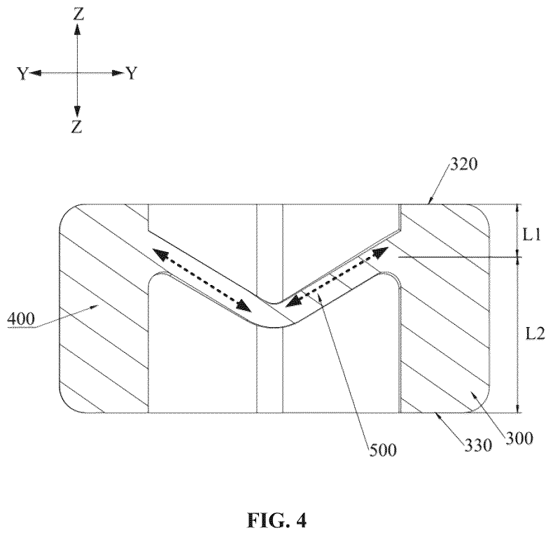

In this embodiment, the elastic support structure 500 is used for supporting the first elastic portion 300 and the second elastic portion 400. As shown in FIG. 1, the elastic support structure 500 is located between the first elastic portion 300 and the second elastic portion 400 and connected to the first elastic portion 300 and the second elastic portion 400. As shown in FIG. 4, the sectional shape of the elastic support structure 500 perpendicular to the first direction X is V-shaped, that is, in any cross section perpendicular to the first direction X, a central portion of the elastic support structure 500 in the second direction Y protrudes toward the same side in the third direction Z. In this manner, the structure of the elastic support structure 500 is conducive to elastic deformation, and the elastic support structure 500 can be deformed with the deformation of the first elastic portion 300 and the second elastic portion 400, thereby providing elastic support for the first elastic portion 300 and the second elastic portion 400.

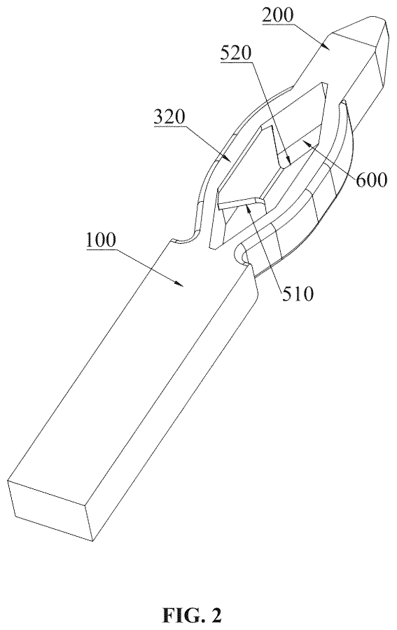

In this embodiment, as shown in FIG. 2, the elastic support structure 500 includes a first end edge 510 facing the main body 100 and a second end edge 520 facing away from the main body 100, that is, the second end edge 520 is disposed toward the pin portion 200. In this embodiment, the first end edge 510 and the second end edge 520 are two end edges of the elastic support structure 500 in the first direction X. The first end edge 510 is at least partially recessed toward the pin portion 200, and the second end edge 520 is at least partially recessed toward the main body 100 so that the length of the elastic support structure 500 in the first direction X can first decrease and then increase in the second direction Y, thereby making the stiffness of the elastic support structure 500 in the second direction Y gradually increase and then gradually decrease. In this manner, in the process of inserting the crimp terminal into the target device, the insertion force applied to the crimp terminal can be smoothly transitioned, that is, an ideal insertion force/insertion displacement curve is generated, so that the insertion process of the crimp terminal can be smoother.

In the crimp terminal provided in this embodiment, the elastic support structure 500 is disposed between the first elastic portion 300 and the second elastic portion 400. After being deformed, the elastic support structure 500 provides an additional elastic force for the first elastic portion 300 and the second elastic portion 400, thereby increasing the holding force between the first elastic portion 300 and the second elastic portion 400 and the target electronic device after the crimp terminal is inserted into the target electronic device, that is, increasing the interaction force between the first elastic portion 300 and the second elastic portion 400 and the target electronic device. In this manner, the connection reliability between the crimp terminal and the target electronic device can be improved, the risk of poor contact between the crimp terminal and the target electronic device can be lowered, and the continuity and stability of electrical signal transmission can be improved.

Furthermore, the cross-sectional shape of the elastic support structure 500 perpendicular to the first direction X is V-shaped, so the insertion force required to overcome the deformation of the first elastic portion 300 and the second elastic portion 400 when the crimp terminal is inserted into the target electronic device can be reduced compared with other shapes, thereby facilitating insertion while also providing a good support force. Moreover, the angle of the V-shaped elastic support structure 500 can also be quickly adjusted to obtain crimp terminals with insertion forces and holding forces in different specifications so that the distance from the first elastic portion 300 to the second elastic portion 400 can be quickly adjusted, and one shape for multiple uses can be derived soon in terms of structural development. Exemplarily, the elastic support structure 500 includes the left and right portions in FIG. 3, and an arc chamfer is disposed at a connection joint between the left and right portions to improve the structural strength of the elastic support structure 500 and lower the probability of breaking the elastic support structure 500.

Optionally, as shown in FIG. 1, one elastic support structure 500 is provided; the crimp terminal having one elastic support structure 500 has a simple structure while ensuring the connection reliability and stability so that the structure of a stamping die used for stamping out the crimp terminal can be simple, the stamping manufacturing process can also be simple, and the manufacturing effect and yield can be greatly improved.

Further, optionally, the elastic support structure 500 is connected to a middle portion of the first elastic portion 300 in the first direction X and a middle portion of the second elastic portion 400 in the first direction X. Since the middle portion of the first elastic portion 300 and the middle portion of the second elastic portion 400 abut against the hole wall of the insertion hole, disposing the elastic support structure 500 to be connected to the middle portion of the first elastic portion 300 and the middle portion of the second elastic portion 400 can specifically support a portion of the first elastic portion 300 and a portion of the second elastic portion 400 that contact the target electronic device, so as to improve the stability and holding force of the crimp terminal contacting the target electronic device.

As shown in FIG. 3, when one elastic support structure 500 is provided, the elastic support structure 500 is disposed in the fisheye hole 600 and separates the fisheye hole 600 into a first through hole 610 and a second through hole 620, that is, the first through hole 610 and the second through hole 620 are separated by the elastic support structure 500. The arrangement of the first through hole 610 and the second through hole 620 not only reduces the overall weight of the crimp terminal, which is conducive to the miniaturization of the crimp terminal, but also reduces, compared with the solid structure, the insertion force required to overcome the deformation of the elastic support structure 500 when the crimp terminal is inserted into the target electronic device, which facilitates the connection of the crimp terminal. In this embodiment, the first through hole 610 is closer to the main body 100 than the second through hole 620.

Exemplarily, as shown in FIG. 3, the first end edge 510 includes a first plane 511 and a second plane 512. The first plane 511 and the second plane 512 are disposed at an included angle. The first plane 511 and the second plane 512 are disposed so that the processing and manufacturing of the first end edge 510 can be facilitated, thereby facilitating the molding of the elastic support structure 500. Additionally, the first plane 511 and the second plane 512 are disposed so that the size of the central portion of the elastic support structure 500 in the first direction X can be smaller compared with the arc surface, or from another perspective, the size of an edge region of the elastic support structure 500 connecting the first elastic portion 300 and the second elastic portion 400 in the first direction X can be large, thereby increasing the connection area of the elastic support structure 500 and the first elastic portion 300 and the second elastic portion 400 on the basis of ensuring a smooth transition of the insertion force. In this manner, the holding force can be applied to more regions of the first elastic portion 300 and the second elastic portion 400 so that the contact area of the first elastic portion 300 and the second elastic portion 400 with the hole wall of the insertion hole can be increased, thereby increasing the contact reliability and stability.

Optionally, a first arc surface 513 may be connected between the first plane 511 and the second plane 512. The first arc surface 513 is disposed so that the first plane 511 and the second plane 512 can have a smooth transition, thereby improving the connection strength between a portion of the elastic support structure 500 where the first plane 511 is located and a portion of the elastic support structure 500 where the second plane 512 is located and further lowering the risk of breaking the elastic support structure 500.

Similar to the first end edge 510, as shown in FIG. 3, the second end edge 520 includes a third plane 521 and a fourth plane 522 that are disposed at an included angle. The third plane 521 and the fourth plane 522 are disposed so that the processing and manufacturing of the second end edge 520 can be facilitated, further facilitating the molding of the elastic support structure 500, and the contact area of the elastic support structure 500 and the first elastic portion 300 and the second elastic portion 400 can be further increased, further improving the support effect.

Exemplarily, a second arc surface 523 may be connected between the third plane 521 and the fourth plane 522. The second arc surface 523 has similar beneficial effects to the first arc surface 513, and details are not repeated in this embodiment.

In some optional embodiments, the fisheye hole 600 in this embodiment is a polygonal hole, that is, the hole wall of the fisheye hole 600 is formed by multiple planes. The fisheye hole 600 is disposed as a polygonal structure so that the size of the fisheye hole 600 can be large, and thereby the deformation range of the first elastic portion 300 and the second elastic portion 400 can be large, which can be applied to a variety of insertion holes of different sizes, thereby improving the versatility of the crimp terminal.

In this embodiment, the fisheye hole 600, the first through hole 610, the second through hole 620, and the elastic support structure 500 are all axisymmetric structures with a symmetry axis so that the force applied to the first elastic portion 300 and the second elastic portion 400 can be uniform, thereby ensuring that both the first elastic portion 300 and the second elastic portion 400 can better contact the hole wall of the insertion hole, the contact area can be increased, and the resistance can also be reduced.

Optionally, as shown in FIG. 3, the first elastic portion 300 includes a first wall surface 311 and a second wall surface 312 that are arranged in the axial direction of the first elastic portion 300. The second elastic portion 400 includes a third wall surface 411 and a fourth wall surface 412 that are arranged in the axial direction of the second elastic portion 400. The first wall surface 311 and the third wall surface 411 are disposed at an included angle, and the second wall surface 312 and the fourth wall surface 412 are disposed at an included angle. Moreover, the first wall surface 311, the third wall surface 411, the first plane 511, and the second plane 512 are used for enclosing and forming the first through hole 610, and the second wall surface 312, the fourth wall surface 412, the third plane 521, and the fourth plane 522 are used for enclosing and forming the second through hole 620.

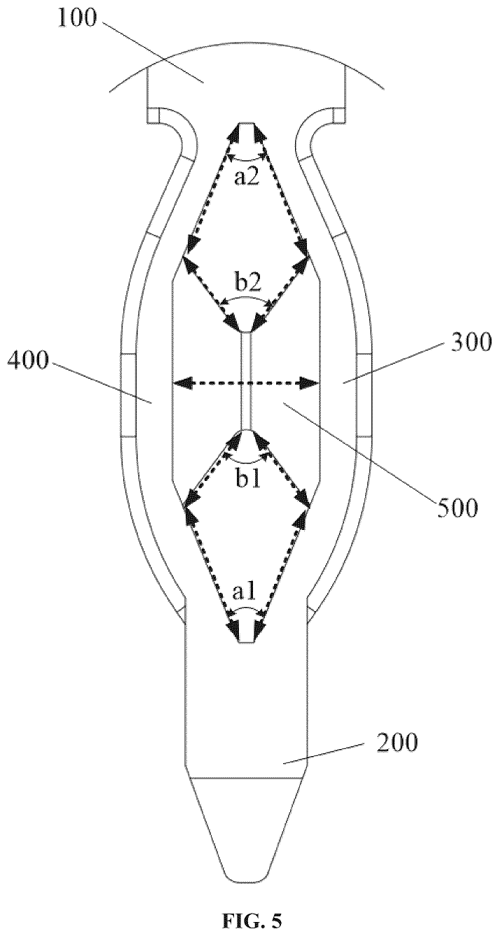

In this embodiment, the first wall surface 311, the second wall surface 312, the third wall surface 411, and the fourth wall surface 412 are all planes so that the first wall surface 311, the second wall surface 312, the third wall surface 411, the fourth wall surface 412, the first plane 511, the second plane 512, the third plane 521, and the fourth plane 522 can be all planes, thereby facilitating force transmission. As shown in FIGS. 4 and 5, after the force is applied to the crimp terminal, the force transmission direction is the dotted line with an arrow in FIG. 5 so that the crimp terminal can obtain a reliable holding force, for example, the failure risk in environmental tests such as thermal shock can be improved.

In some optional embodiments, with continued reference to FIG. 3 and FIG. 5, the included angle between the first wall surface 311 and the third wall surface 411 is a1, and the included angle between the first plane 511 and the second plane 512 is b1, where b1>a1. The included angle between the first wall surface 311 and the third wall surface 411 is smaller than the included angle between the first plane 511 and the second plane 512 so that the holding force of the crimp terminal can be further increased.

Similarly, the included angle between the second wall surface 312 and the fourth wall surface 412 is a2, and the included angle between the third plane 521 and the fourth plane 522 is b2, where b2>a2. The included angle between the second wall surface 312 and the fourth wall surface 412 is smaller than the included angle between the third plane 521 and the fourth plane 522 so that the holding force of the crimp terminal can be further increased.

In some optional embodiments, a2 and a1 are both acute angles, and b1 and b2 may be acute angles, obtuse angles, or right angles.

Optionally, a2=a1, and b1=b2 so that the force can be applied to the first elastic portion 300 and the second elastic portion 400 more uniformly, and so that the first elastic portion 300 and the second elastic portion 400 can better abut against the hole wall of the insertion hole, thereby ensuring the contact effect.

Exemplarily, with continued reference to FIG. 3, the first elastic portion 300 further includes a fifth wall surface 313 connected between the first wall surface 311 and the second wall surface 312. The second elastic portion 400 further includes a sixth wall surface 413 connected between the third wall surface 411 and the fourth wall surface 412.

The first plane 511 intersects the first wall surface 311, and a position at which the first plane 511 intersects the first wall surface 311 is different from a position at which the first wall surface 311 intersects the fifth wall surface 313. The second plane 512 intersects the third wall surface 411, and a position at which the second plane 512 intersects the third wall surface 411 is different from a position at which the third wall surface 411 intersects the sixth wall surface 413. The third plane 521 intersects the second wall surface 312, and a position at which the third plane 521 intersects the second wall surface 312 is different from a position at which the second wall surface 312 intersects the fifth wall surface 313. The fourth plane 522 intersects the fourth wall surface 412, and a position at which the fourth plane 522 intersects the fourth wall surface 412 is different from a position at which the fourth wall surface 412 intersects the sixth wall surface 413. In this manner, the sizes of two ends of the elastic support structure 500 can be large to ensure the connection effect, and the included angle between the first plane and the second plane and the included angle between the third plane and the fourth plane can be ensured not to be too large, thereby increasing the overall holding force of the crimp terminal.

In some optional embodiments, as shown in FIG. 3, the fifth wall surface 313 and the sixth wall surface 413 may also be planes. Certainly, it is to be understood that the fifth wall surface 313 and the sixth wall surface 413 may not be planes, which is not limited in this embodiment.

Optionally, as shown in FIG. 4, the first elastic portion 300 has a first side surface 320 and a second side surface 330 that are opposite to each other in the third direction Z. The distance from a connection position of the elastic support structure 500 and the first elastic portion 300 to the first side surface 320 is L1, the distance from the connection position of the elastic support structure 500 and the first elastic portion 300 to the second side surface 330 is L2, and L1<L2; a middle portion of the elastic support structure 500 extends toward the second side surface 330. The connection position of the elastic support structure 500 and the first elastic portion 300 is disposed to deviate from a middle portion of the first elastic portion 300 in the third direction Z so that the elastic support structure 500 can have a large movement space in the third direction Z and cannot extend outside the fisheye hole 600, thereby making the sizes of the elastic support structure 500 in the first direction X, the second direction Y, and the third direction Z large and ensuring sufficient support force and deformation amplitude.

Similarly, the second elastic portion 400 has a third side surface and a fourth side surface that are opposite to each other in the third direction Z. The distance from a connection position of the elastic support structure 500 and the second elastic portion 400 to the third side surface is longer than the distance from the connection position of the elastic support structure 500 and the second elastic portion 400 to the fourth side surface; the third side surface and the first side surface 320 are located on one side of the elastic support structure 500 in the third direction Z, and the second side surface 330 and the fourth side surface are located on the other side of the elastic support structure 500 in the third direction Z. In this manner, the elastic support structure 500 can be regular in shape and easy to process and manufacture and can further increase the deformation space of the elastic support structure 500.

The crimp terminal provided in this embodiment has a simple structure, is easy to process and manufacture, and can improve production efficiency. Moreover, the crimp terminal can have a large usage range, have high versatility, and also improve the holding force when connected to the target electronic device.

In a second aspect, this embodiment provides a crimp connector. The crimp connector includes the crimp terminal in the first aspect. The crimp connector provided in this embodiment has high connection stability and reliability.

In a third aspect, this embodiment provides an electronic device. The electronic device includes the crimp connector in the second aspect. The electronic device provided in this embodiment also includes a printed circuit board, and the crimp terminal of the crimp connector can be inserted into the printed circuit board so that the electronic device can have high continuity and reliability of electrical signal transmission.

Exemplarily, the electronic device may be a network server, a vehicle, or a home appliance, which is not limited thereto.

Apparently, the preceding embodiments of the present disclosure are examples to clearly describe the present disclosure and are not intended to limit implementations of the present disclosure. Those of ordinary skill in the art can make various apparent modifications, adaptations, and substitutions without departing from the scope of the present disclosure. All embodiments do not need to be and cannot be exhausted herein.

What is claimed is:

1. A crimp terminal, comprising:
a main body;
a pin portion, spaced apart from the main body in a first direction;
a first elastic portion, connected between the main body and the pin portion, wherein the first elastic portion is at least deformable in a second direction perpendicular to the first direction;
a second elastic portion, connected between the main body and the pin portion and spaced apart from the first elastic portion in the second direction, wherein the second elastic portion is at least deformable in the second direction; and
an elastic support structure, located between the first elastic portion and the second elastic portion and connected to the first elastic portion and the second elastic portion, wherein a cross-sectional shape of the elastic support structure perpendicular to the first direction is V-shaped; the elastic support structure comprises a first end edge facing the main body and a second end edge facing away from the main body; the first end edge is at least partially recessed toward the pin portion, and the second end edge is at least partially recessed toward the main body.

2. The crimp terminal according to claim 1, further comprising at least one of the following:
the first end edge comprises a first plane and a second plane that are disposed at an included angle; or
the second end edge comprises a third plane and a fourth plane that are disposed at an included angle.

3. The crimp terminal according to claim 1, wherein the elastic support structure is provided in a quantity of one, and the elastic support structure is connected to a middle portion of the first elastic portion in the first direction and a middle portion of the second elastic portion in the first direction.

4. The crimp terminal according to claim 3, wherein a fisheye hole is enclosed by the main body, the pin portion, the first elastic portion, and the second elastic portion, and the elastic support structure is disposed in the fisheye hole and separates the fisheye hole into a first through hole and a second through hole.

5. The crimp terminal according to claim 4, wherein the fisheye hole, the first through hole, the second through hole, and the elastic support structure are all axisymmetric structures, and symmetry axes of the fisheye hole, the first through hole, the second through hole, and the elastic support structure coincide and extend along the first direction.

6. The crimp terminal according to claim 2, wherein the first elastic portion comprises a first wall surface and a second wall surface, and the second elastic portion comprises a third wall surface and a fourth wall surface; the first wall surface and the third wall surface are disposed at an included angle, and the second wall surface and the fourth wall surface are disposed at an included angle; the first wall surface, the second wall surface, the third wall surface, and the fourth wall surface are all planes.

7. The crimp terminal according to claim 6, wherein the included angle between the first wall surface and the third wall surface is a1, and the included angle between the first plane and the second plane is b1, wherein b1>a1; and
the included angle between the second wall surface and the fourth wall surface is a2, and the included angle between the third plane and the fourth plane is b2, wherein b2>a2.

8. The crimp terminal according to claim 6, wherein the first elastic portion further comprises a fifth wall surface connected between the first wall surface and the second wall surface; the second elastic portion further comprises a sixth wall surface connected between the third wall surface and the fourth wall surface; and
the first plane intersects the first wall surface, and a position at which the first plane intersects the first wall surface is different from a position at which the first wall surface intersects the fifth wall surface; the second plane intersects the third wall surface, and a position at which the second plane intersects the third wall surface is different from a position at which the third wall surface intersects the sixth wall surface; the third plane intersects the second wall surface, and a position at which the third plane intersects the second wall surface is different from a position at which the second wall surface intersects the fifth wall surface; the fourth plane intersects the fourth wall surface, and a position at which the fourth plane intersects the fourth wall surface is different from a position at which the fourth wall surface intersects the sixth wall surface.

9. The crimp terminal according to claim 1, wherein the first elastic portion has a first side surface and a second side surface that are opposite to each other in a third direction; a distance from a connection position of the elastic support structure and the first elastic portion to the first side surface is L1, a distance from the connection position of the elastic support structure and the first elastic portion to the second side surface is L2, and L1□L2; a middle portion of the elastic support structure extends toward the second side surface, wherein the third direction is perpendicular to both the first direction and the second direction.

10. The crimp terminal according to claim 2, wherein the elastic support structure is provided in a quantity of one, and the elastic support structure is connected to a middle portion of the first elastic portion in the first direction and a middle portion of the second elastic portion in the first direction.

11. The crimp terminal according to claim 2, wherein the first elastic portion has a first side surface and a second side surface that are opposite to each other in a third direction; a distance from a connection position of the elastic support structure and the first elastic portion to the first side surface is L1, a distance from the connection position of the elastic support structure and the first elastic portion to the second side surface is L2, and L1□L2; a middle portion of the elastic support structure extends toward the second side surface, wherein the third direction is perpendicular to both the first direction and the second direction.

12. A crimp connector, comprising a crimp terminal, wherein the crimp terminal comprises:
a main body;
a pin portion, spaced apart from the main body in a first direction;
a first elastic portion, connected between the main body and the pin portion, wherein the first elastic portion is at least deformable in a second direction perpendicular to the first direction;
a second elastic portion, connected between the main body and the pin portion and spaced apart from the first elastic portion in the second direction, wherein the second elastic portion is at least deformable in the second direction; and
an elastic support structure, located between the first elastic portion and the second elastic portion and connected to the first elastic portion and the second elastic portion, wherein a cross-sectional shape of the elastic support structure perpendicular to the first direction is V-shaped; the elastic support structure comprises a first end edge facing the main body and a second end edge facing away from the main body; the first end edge is at least partially recessed toward the pin portion, and the second end edge is at least partially recessed toward the main body.

13. The crimp connector according to claim 12, further comprising at least one of the following:
the first end edge comprises a first plane and a second plane that are disposed at an included angle; or
the second end edge comprises a third plane and a fourth plane that are disposed at an included angle.

14. The crimp connector according to claim 12, wherein the elastic support structure is provided in a quantity of one, and the elastic support structure is connected to a middle portion of the first elastic portion in the first direction and a middle portion of the second elastic portion in the first direction.

15. The crimp connector according to claim 14, wherein a fisheye hole is enclosed by the main body, the pin portion, the first elastic portion, and the second elastic portion, and the elastic support structure is disposed in the fisheye hole and separates the fisheye hole into a first through hole and a second through hole.

16. The crimp connector according to claim 15, wherein the fisheye hole, the first through hole, the second through hole, and the elastic support structure are all axisymmetric structures, and symmetry axes of the fisheye hole, the first through hole, the second through hole, and the elastic support structure coincide and extend along the first direction.

17. The crimp connector according to claim 13, wherein the first elastic portion comprises a first wall surface and a second wall surface, and the second elastic portion comprises a third wall surface and a fourth wall surface; the first wall surface and the third wall surface are disposed at an included angle, and the second wall surface and the fourth wall surface are disposed at an included angle; the first wall surface, the second wall surface, the third wall surface, and the fourth wall surface are all planes.

18. The crimp connector according to claim 17, wherein the included angle between the first wall surface and the third wall surface is a1, and the included angle between the first plane and the second plane is b1, wherein b1>a1; and
the included angle between the second wall surface and the fourth wall surface is a2, and the included angle between the third plane and the fourth plane is b2, wherein b2>a2.

19. The crimp connector according to claim 17, wherein the first elastic portion further comprises a fifth wall surface connected between the first wall surface and the second wall surface; the second elastic portion further comprises a sixth wall surface connected between the third wall surface and the fourth wall surface; and
the first plane intersects the first wall surface, and a position at which the first plane intersects the first wall surface is different from a position at which the first wall surface intersects the fifth wall surface; the second plane intersects the third wall surface, and a position at which the second plane intersects the third wall surface is different from a position at which the third wall surface intersects the sixth wall surface; the third plane intersects the second wall surface, and a position at which the third plane intersects the second wall surface is different from a position at which the second wall surface intersects the fifth wall surface; the fourth plane intersects the fourth wall surface, and a position at which the fourth plane intersects the fourth wall surface is different from a position at which the fourth wall surface intersects the sixth wall surface.

20. The crimp connector according to claim 12, wherein the first elastic portion has a first side surface and a second side surface that are opposite to each other in a third direction; a distance from a connection position of the elastic support structure and the first elastic portion to the first side surface is L1, a distance from the connection position of the elastic support structure and the first elastic portion to the second side surface is L2, and L1□L2; a middle portion of the elastic support structure extends toward the second side surface, wherein the third direction is perpendicular to both the first direction and the second direction.
